(19) United States
(12) Patent Application Publication
(10) Pub. No.: US 2013/0228334 A1
(43) Pub. Date: Sep. 5, 2013

(54) METHOD AND COMPOSITION TO REDUCE GEL VISCOSITY IN THE INTERMEDIATE TEMPERATURE RANGE

(71) Applicants: Li Jiang, Kathy, TX (US); Syed A. Ali, Sugar Land, TX (US); Michael D. Parris, Richmond, TX (US); Richard D. Hutchins, Sugar Land, TX (US); Gbenga Ogunlaja, Houston, TX (US)

(72) Inventors: Li Jiang, Kathy, TX (US); Syed A. Ali, Sugar Land, TX (US); Michael D. Parris, Richmond, TX (US); Richard D. Hutchins, Sugar Land, TX (US); Gbenga Ogunlaja, Houston, TX (US)

(21) Appl. No.: 13/595,644

(22) Filed: Aug. 27, 2012

Related U.S. Application Data
(60) Provisional application No. 61/575,810, filed on Aug. 29, 2011.

(51) Int. Cl. C09K 8/60; E21B 43/26

(52) U.S. Cl. CPC C09K 8/60; E21B 43/26
USPC 166/300; 166/308.2

(57) ABSTRACT

Methods for reducing a viscosity of a viscosified fluid include reacting, such as by depolymerizing and/or decomposing, a polymeric material of the viscosified fluid with a breaking agent including one or more organic peroxide breakers having a structural feature selected from a cyclic peroxide segment and/or multiple linear peroxide moieties per molecule. The methods of treating the subterranean are provided that include reacting, such as by depolymerizing and/or decomposing, a polymeric material of a viscosified treatment fluid with one or more organic peroxide breakers having a structural feature selected from cyclic peroxide segment and/or multiple linear peroxide moieties per molecule to facilitate breaking of the viscosified treatment fluid after the fracturing or treatment is finished.

### CROSS REFERENCE

This application claims the benefit of a related U.S. Provisional Application Ser. No. 61/575,810, which was filed on Aug. 29, 2011, entitled “METHOD AND COMPOSITION TO REDUCE GEL VISCOSITY IN MIDDLE TEMPERATURE RANGE,” to Jiang et al., the disclosure of which is incorporated herein by reference in its entirety.

### BACKGROUND

Hydrocarbons (natural, gas, etc) are obtained from a subterranean geologic formation “reservoir”) by drilling a well that penetrates the hydrocarbon-bearing formation. In the process of recovering hydrocarbons from subterranean formations, it is common practice to treat a hydrocarbon-bearing formation with a pressurized fluid to provide flow channels, i.e., to fracture the formation, or to use such fluids to transport and place proppant to facilitate flow of the hydrocarbons to the wellbore.

Well treatment fluids, particularly those used in fracturing (fracturing fluids), may comprise a water or oil based fluid incorporating a thickening agent, normally a polymeric material. Polymeric thickening agents for use in such fluids may comprise galactomannan gums, such as guar and substituted guars such as hydroxypropyl guar and carboxymethylhydroxypropyl guar (CMHPG). Cellulosic polymers such as carboxymethyl cellulose may also be used, as well as synthetic, polymers such as polyacrylamide. Such fracturing fluids can have a high viscosity during a treatment to develop a desired fracture geometry and/or to carry proppant into a formation with sufficient resistance to settling.

The recovery of the fracturing fluid is achieved by reducing the viscosity of the fluid such that the fluid flows naturally through the proppant pack. Chemical reagents, such as oxidizers, chelants, acids and enzymes may be employed to break the polymer networks to reduce their viscosity. These materials axe commonly referred to as “breakers” or “breaking agents.” Such conventional fracturing fluid breaking technologies are known and work well at relatively low and high temperatures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, the present disclosure relates to methods for reducing the viscosity of a viscosified fluid. Such methods may include introducing a viscosified fluid into a subterranean formation, and reducing the viscosity of the viscosified fluid by reacting a polymeric material (such as by depolymerizing and/or decomposing the polymeric material) of the viscosified fluid with is breaking agent including at least one organic peroxide having a structural feature selected from a cyclic peroxide segment and/or multiple linear peroxide moieties per molecule. The viscosity of the viscosified fluid in the subterranean formation may be reduced by at least an order of magnitude while at a temperature in the range of from about 175° F. (79.4° C.) to about 275° F. (135° C.).

The present disclosure also relates to methods of treating a subterranean formation penetrated by a wellbore, which include forming a viscosified treatment fluid, treating the subterranean formation with the viscosified treatment fluid to fracture the subterranean formation. After the subterranean formation has been fractured, the viscosity of the viscosified treatment fluid is reduced by at least 80% by introducing a breaking agent to the viscosified treatment fluid. The breaking agent includes at least one organic peroxide having a structural feature selected from a cyclic peroxide segment and/or multiple linear peroxide moieties per molecule. The viscosity of the viscosified treatment fluid that treated the subterranean formation may be reduced by the breaking effect of the breaking agent by at feast while the viscosified treatment fluid is at a temperature in the range of from about 175° F. (79.4° C.) to about 275° F. (135° C.).

### BRIEF DESCRIPTION OF THE DRAWINGS

The manner in which the objectives of the present disclosure and other desirable characteristics may be obtained is explained in the following description and attached drawings in which;

FIG. 1 shows a plot of the viscosity over time of gelled polymer solutions (Example 1) containing a breaker (3,6,9-triethyl-3,6,9-trimethyl-1,4,7-triperoxonane) in the presence of an oligoamine activator at various temperatures.

FIG. 2 shows a plot of the viscosity over in of gelled polymer solutions (Example 2) containing a breaker (1,1-di(tert-butylperoxy)-3,3,5-trimethylcyclohexane) in the presence of an oligoamine activator at various temperatures.

FIG. 3 shows a plot of the viscosity over time of crosslinked gelled polymer solutions (Example 3) containing as breaker (1,1-di(tert-butylperoxy)trimethylcyclohexane) the presence of an oligoamine activator at various temperatures.

FIG. 4 shows a plot of the viscosity over time of gelled polymer solutions (Example 4) containing a breaker (1-di(tert-butylperoxy)-3,3,5-trimethylcyclohexane) in the presence of organic and inorganic peroxides.

FIG. 5 shows a plot of the viscosity over time of crosslinked gelled polymer solutions (Example 5) containing a breaker (1,1-di(tert-butylperoxy)-3,3,5-trimethylcyclohexane) in the absence of any activator.

FIG. 6 shows a plot of the viscosity over time or gelled polymer solutions (Example 6) containing multiple activators (ammonium chloride and urea).

FIG. 7 shows a plot of the viscosity over time at gelled polymer solutions (Example 7) containing multiple activators (ammonium chloride and area).

### DETAILED DESCRIPTION

In the following description, numerous details are set forth to provide an understanding or the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure, in addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range.

The present disclosure is generally directed toward breaking fracturing fluids or viscosified fluids in a controlled fashion using a breaking agent (also referred to as a “breaker”) comprising at least one organic peroxide having a structural feature selected from cyclic peroxide segment and/or multiple linear peroxide moieties per molecule. In embodiments, breaking the viscosified fluids with a breaking agent comprising at least one organic peroxide having a structural feature selected from cyclic peroxide segment and/or multiple linear peroxide moieties per molecule occurs at an intermediate temperature. The phrase “intermediate temperature” refers, for example, to a temperature in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.).

The methods of the present disclosure may also include treating a subterranean formation penetrated by a wellbore. Such methods may comprise contacting and/or reacting viscosified treatment fluid, such as a viscosified polymer treatment fluid introduced into the formation via the wellbore, with to breaking agent comprising at least one organic peroxide having a structural feature selected from cyclic peroxide segment and/or multiple linear peroxide moieties per molecule. In embodiments, the methods of the present disclosure facilitate breaking of the viscosified treatment fluid after the fracturing or treatment is finished.

In embodiments, the “action” of the viscosified fluid (viscosified treatment fluid” or “viscosified fluid for treatment) with the breaking agents or breakers to reduce the viscosity of the viscosified thud (the breaking effect) occurs at intermediate temperatures, in embodiments, the “reaction” of the viscosified fluid viscosified fluid (viscosified treatment fluid” or “viscosified fluid for treatment) with the breaking agents or breakers to reduce the viscosity of the viscosified fluid the breaking effect) does not substantially occur, or does not occur, until the breaking agent is exposed to the subterranean conditions, such as a temperature in the range of from about 79.4° C. (175° F.) to about 135° C., (275° F.), such as from about 79.4° C. (175° F.) to about 121° C. (250° F.), from about 93.3° C., (200° F.) to about 121° C. (250° F.), or from about 93.3° C. (200° F.) to about 107° C. (2251° F.). In some embodiments, such a reaction, which may include the breaking agent reacting with the polymeric material of the viscosified fluid to decompose and/or depolymerize the polymeric material of the viscosified fluid, does not substantially occur, or does not occur, until the breaking agent is down hole and exposed to heat, such as a sufficient heat to initiate the breaking effect of the breaking agent.

The design of fracturing treatments is described in U.S. Pat. No. 7,337,39, which is incorporated herein by reference in it entirety. Although the present disclosure describes the use of a breaking agent comprising one or more organic peroxide haying a structural feature selected from cyclic peroxide segment and/or multiple linear peroxide moieties per molecule in fracturing treatments, it can also be used in other treatments.

The phrase “breaking agent comprising at least one organic peroxide” refers, for example, to breaking agents comprising at least one organic peroxide molecule having a structural feature selected from cyclic peroxide segment and/or multiple linear peroxide moieties per molecule.

An organic peroxide molecule having a “cyclic peroxide segment,” refers, for example, to a cyclic peroxide that has a ring structure of about $ to about 16 atoms, such as a ring structure of about 5 to about 1.2 atoms, or a ring structure of 6 to about 10 atoms, where at least one peroxy structure R₁—O—O—R₂ is incorporated into ring of the cyclic peroxide. In such structures, R₁ and R₂, independently, are alkylene groups that may join together to form the cyclic peroxide ring structure and make up the remaining portion of the cyclic structure. The cyclic peroxide may also contain about 1 to about 6 supplemental oxygen atoms, such as about 2 to about 5 supplemental oxygen atom, or about 3 to about 4 supplemental oxygen atoms, in the cyclic structure (such as a total of about 3 to about 8 oxygen atoms in the cyclic peroxide structure, or a total of about 4 to about 6 oxygen atoms in the cyclic peroxide structure), which may be separated by one or more additional alkylene groups (such as, for example, an additional alkylene group R₃ in between the supplemental oxygen atoms in the cyclic peroxide structure; or optionally two further alkylene groups R₃ and R₄, such as, for example, in a 12 atom cyclic peroxide ring containing 8 oxygen atoms in which each alkylene group (R₁, R₂, R₃ and R₄) is separated by two oxygen atoms).

The alkylene groups that form to part of the cyclic peroxide ring structure refer, for example, to a divalent aliphatic group or alkyl group, including, linear and branched, saturated and unsaturated, and substituted and unsubstituted alkylene groups, and wherein heteroatoms, such as oxygen, nitrogen, sulfur, silicon, phosphorus, boron, Mg, Li, Ge, Cu, Fe, Ni, Pd, Pt and the like either may or may not be present in the alkylene group. For example, an alkylene group may represent a divalent structure that can be linear or branched, saturated or unsaturated, and substituted or unsubstituted and have as structure including from about 1 to about 29 atoms, such as from about 2 to abut 15, or about 3 to about 10 atoms.

In embodiments, a breaking, agent may include, for example, as 9 atom ring structure having a cyclic peroxide segment, represented by Formula I:

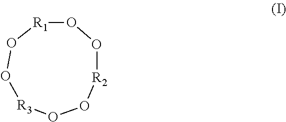

where R₁, R₂, and R₃, independently, are alkylene groups. A compound represented by Formula I may include 3,6,9-triethyl-3,6,9-trimethyl-1,4,7-triperoxonane, the structure of which is shown below (Formula II):

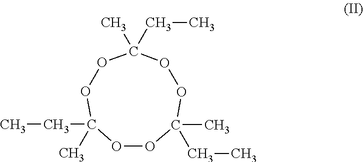

in which R₁, R₂, and R₃ with respect to the atoms incorporated into the 9 atom ring structure) are each represented by methylene groups having methyl and ethyl substituents. Further compounds represented by Formula I may include homologs of the compound of Formula II where the methyl and/or ethyl groups are replaced by a linear or branched alkyl group.

For example, homologs of the compound of Formula II may include structures in which one or more of the above methyl and/or ethyl groups, independently of one another, are replaced by a linear alkyl group baying about 1 to about 20 carbon atoms, such as about 2 to about 16 carbon atoms, or about 4 to about 10 carbon atoms, which may or may not be substituted. In some embodiments, one or more of the above methyl and/or ethyl groups (of the compound of Formula II), independently of one another, may be replaced by hydrogen, a linear alkyl group, or branched alkyl group, the linear alkyl group or branched alkyl group having about 1 to about 20 carbon atoms, such as about 2 to about 16 carbon atoms, of about 4 to about 10 carbon atoms, which may or may not be substituted. Suitable linear or branched alkyl groups may include methyl, ethyl, n-propyl, isopropyl, in-butyl, isobutyl, tert-butyl, sec-butyl, tert-butyl, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, and a nonadecyl group, any of which may or may not be substituted. Suitable linear or brandied alkyl groups may also include any structural isomer of a pentyl group, a hexyl group a heptyl group, an octyl group, as nonyl group, a decyl goop, an undecyl group, a dodecyl group, a tridecyl group, a tetradecyl group, a pentadecyl group, a hexadecyl group, a heptadecyl group, an octadecyl group, and a nonadecyl group, any of which may or may not be substituted.

A breaking agent may also be represented by a 7 atom cyclic peroxide structure, such as, for example, Formula III:

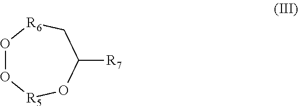

where R₅ and R₆, independently, are alkylene groups and R₇ is a hydrogen or a linear or branched alkyl group having about 1 to about 20 carbon atoms, such as about 2 to about 16 carbon atoms, or about 4 to about 10 carbon atoms which may or may not be substituted. Suitable linear or branched alkyl groups may include those identified above with respect to Formulas 1 and 2.

A compound represented by Formula III may include 3,3,5,7,7-pentamethyl-1,2,4-trioxepane, the structure a which is shown below (Formula IV):

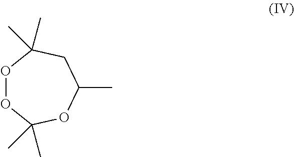

The substituents on the substituted alkylene and alkyl groups can be, for example, halogen atoms, ether groups, aldehyde groups, ketone groups, ester groups, amide groups, imide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid, anhydride groups, azide groups, azo groups, cyanato groups, isocyanato groups, thiocyanato groups, isothiocyanato groups, cyano groups, pyridine groups, pyridinium groups, guanidinium group, amidine groups, imidazolium groups, carboxylate groups, carboxylic acid groups, urethane groups, urea groups, and mixtures thereof.

A molecule having “multiple linear peroxide moieties per molecule,” refers, for example, to a single molecule including at least about 2 peroxy structures represented by R₈—O—O—R₉, such as about 2 to about 8 peroxy structures in a single molecule, or about 4 to about 6 peroxy structures in a single molecule; where R₈ and R₉, independently, are as hydrocarbon group, including linear and branched, saturated and unsaturated; and substituted and unsubstituted hydrocarbon groups, and wherein heteroatoms, such as oxygen, nitrogen, sulfur, silicon, phosphorus, boron, Mg, Li, Ge, en, Fe, Ni, Pd, Pt and the like either may or may not be present in the hydrocarbon group.

In Embodiments, the at least 2 peroxy structures may be bonded together by at least one intervening (a) alkylene group, such as an alkylene group having 1 to about 40 carbon atoms, or about 4 to about 20 carbon atoms, or about 6 to about 10 carbon atoms, wherein hetero atoms either may or may not be present in the alkylene group, (b) arylene group, such as an arylene pour) having about 5 to about 40 carbon atoms, or about 6 to about 14 carbon atoms, or about 6 to about 10 carbon atoms, wherein hetero atoms either may or may not be present in the arylene group, (c) arylalkylene group, such as an arylalkylene group having about 6 to about 40 carbon atoms, or about 7 to about 22 carbon atoms, or about 7 to about 20 carbon atoms, wherein hetero atoms either may or may not be present in either or boat of the alkyl portion and the aryl portion of the arylalkylene group; or (d) alkylarylene group, such as an arylalkylene group baying about 6 to about 40 carbon atoms, or about 7 to about 22 carbon atoms, or about 7 to about 20 carbon atoms, wherein hetero atoms either may or may not be present in either or both of the alkyl portion and the aryl portion of the alkylarylene group.

An “alkylene group” that may have multiple linear peroxide moieties bonded thereto refers, for example, to at least as divalent aliphatic group or alkyl group, such as at trivalent or tetravalent aliphatic group or alkyl group, including linear and branched, saturated and unsaturated, cyclic, and acyclic, and substituted and unsubstituted alkylene groups, and wherein heteroatoms, such as oxygen, nitrogen, sulfur, silicon, phosphorus, boron, Mg, Li, Ge, Cu, Fe, Ni, Pd, Pt and the like either may or may not be present in the alkylene group. The term “arylene” refers, for example, to at least a divalent aromatic group or aryl group, such as a trivalent or tetravalent aromatic group or aryl group, including substituted and unsubstituted arylene groups, and wherein heteroatoms, such as O, N, S, P, Si, B, Li, Mg, Cu, Fe and the like either may or may not be present in the arylene group. For example, an arylene group may have about 5 to about 40 carbon atoms iii the arylene chain, such as from about 6 to about 14 or from about 6 to about 10 carbon atoms.

The term “arylalkylene” refers, for example, to at least a divalent arylalkyl group, such as a trivalent or tetravalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as O, N, S, P, Sr, B, Li, Mg, Cu, Fe, and the like either may or may not be present in either the aryl or the alkyl portion of the arylalkylene group. For example, an arylalkylene group may have about 6 to about 40 carbon atoms in the arylalkylene chain, such as from about 7 to about 22 or from about 7 to about 20 carbon atoms.

The term “alkylarylene” refers, fir example, to at least a divalent alkylaryl group, such as a trivalent or tetravalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as O, N, S, P, Si, Ge, B, Li, Mg, Cu, Fe, Pd, Pt and the like either may or may not be present in either the aryl or the alkyl portion of the alkylarylene group. For example, the alkylarylene may have about 6 to about 40 carbon atoms in the alkylarylene chain, such as from about 7 to about 22 or from about to about 20 carbon atoms.

The substituents on the substituted hydrocarbon, alkylene, arylene arylalkylene, and alkylarylene groups can be for example, halogen atoms, ether groups, aldehyde groups, ketone groups, ester groups, amide groups, imide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, cyano groups, pyridine groups, pyridinium groups, guanidinium groups, amidine groups, imidazolium groups, carboxylate groups, carboxylic add groups, urethane groups, urea groups, and mixtures thereof.

Molecules having multiple linear peroxide moieties per molecule may include 1,1-di(tert-butylperoxy)-3,3,5-trimethylcyclohexane, 2,5-dimethyl-2,5-di(tert butylperoxy)hexyne-3, and 2,5,-dimethyl-2,5-di(tert butylperoxy)hexane, which are represented by Formulas V, VI, and VII, respectively:

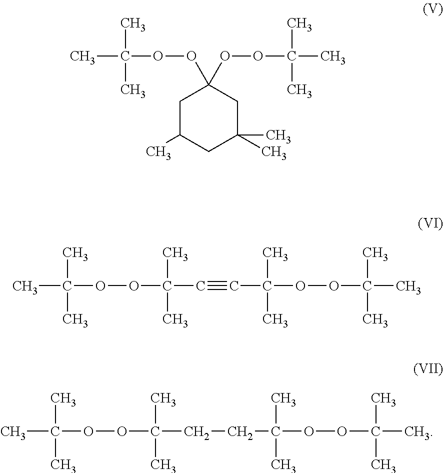

The breaking agent or breaker comprising one or more organic peroxide may initially be in a solid or liquid form. When in a solid form, the organic peroxide may be crystalline or granular materials. The solid form may be encapsulated or provided with a coating to delay its release into the treatment fluid. Encapsulating materials and methods of encapsulating breaking materials are known in the art. Such materials and methods may be used for the breaker comprising one or more organic peroxide of the present disclosure. Non-limiting examples of materials and methods that may be used for encapsulation are described, for instance, in U.S. Pat. Nos. 4,741,401; 4,919,209; 6,162,766 and 6,357,527, the disclosures of which are incorporated herein by reference in their entireties.

When used as a liquid or fluid, the breaking agent comprising one or more organic peroxide is commonly dissolved in an aqueous solution. The breaking agent comprising one or more organic peroxide is generally soluble in water, that is, the breaking agents have a solubility of at least greater than 1 g in 100 g of water at room temperature, as measured using iodometric titration methods. The breaking agent comprising one or more organic peroxide of the present disclosure may have solubilities of 5 g or more in 100 g of water, such as 10 g or more in 100 g of water.

The breaker or breaking agent may be added to the viscosified or unviscosified treatment fluid before this fluid is introduced into the well bore, or the breaker or breaking agent may be added as a separate fluid, such as an aqueous or organic based fluid, that is introduced into the wellbore after at least a portion or the entire, amount of viscosified or unviscosified treatment fluid has been introduced into the wellbore.

The amount of the breaker present in the viscosified or unviscosified treatment fluid (or aqueous or organic based fluid) may depend on several factors including the specific breaker selected, the amount and ratio of the other components in the viscosified or unviscosified treatment fluid (or aqueous or organic based fluid), the contacting time, desired, the temperature, pH, and ionic strength of the viscosified or unviscosified treatment fluid (or aqueous or organic based fluid).

In embodiments where in the breaking agent is introduced in a fluid separate from the viscosified or unviscosified fluid, the breaking, agent may be incorporated into an aqueous or organic based fluid in which the breaking agent may present in an amount above about 0.001%, by weight of the aqueous or organic based fluid, such as in an amount from about 0.002% to about 0.1% by weight of aqueous or organic based fluid, in an amount from about 0.003% to about 0.01% by weight of the aqueous or organic based fluid or in an amount from about 0.004% to about 0.008% by weight of the aqueous or organic based fluid.

The breaking agent may be present in the viscosified or unviscosified fluid (added before introducing the viscosified or unviscosified treatment fluid into the wellbore) in an amount above about 0.001% by weight of the viscosified or unviscosified fluid, such a in an amount from about 0.01% to about 0.6%, by weight of the viscosified or unviscosified in an amount from about 0.04% to about 0.3% by weight of the viscosified or unviscosified fluid, or in an amount from about 0.05% to about 0.01% by weight of the viscosified or unviscosified fluid. In such embodiments, the concentration ratio of the breaker to the polymeric material (breaker:polymeric material) in the viscosified or unviscosified fluids may be in a range of from about 1:100 to about 1:4, such as a concentration ratio in range of from about 1:50 to about 1:5, a concentration ratio in range of from about 1:40 to about 1:6, or a concentration ratio in range of from about 1:30 to about 1:7.

As used herein, the phrases “viscosified fluid,” “viscosified treatment fluid” or “viscosified fluid for treatment” (hereinafter generally referred to as a “viscosified fluid” unless specified otherwise) mean, for example, a composition comprising a solvent, a viscosifying material, such as a polymeric material, which may include any crosslinkable compound and/or substance with a crosslinkable moiety (hereinafter “crosslinkable component”), and optionally one or more organic peroxide breakers having a structural feature selected from cyclic peroxide segment and/or multiple linear peroxide moieties per molecule. The viscosified fluids of the present disclosure may be substantially inert to any produced fluids (gases and liquids and other fluids injected into the wellbore or around the wellbore.

The breaking agents or breakers of the present disclosure may be activated to initiate the “reaction” of the viscosified treatment fluid with the breaking agents or breakers to reduce the molecular weight of the polymeric materials (the breaking effect). In embodiments, the breaking agents or breakers of the present disclosure may be initiated by subterranean environmental conditions, such as temperature or pH of the subterranean zone in which they are placed.

In embodiments when breaker or breaking agent is added to the viscosified or unviscosified treatment fluid either before or after the fluid is introduced into the well bore, the “reaction” of the viscosified treatment thud with the breaking agents or breakers (the breaking effect) does not substantially occur mull the breaking agent is exposed to an intermediate temperature, such as downhole or subterranean conditions where the temperature is in the range of from about 79.4° C. (175° F.) to about 135° C. (275° F.), such as from about 79.4° C. (175° F.) to about 121° C. (250° F.), from about 93.3° C. (200° F.) to about 121° C. (251° F.), or from about 93.3° C. (200° F.) to about 107° C. (225° F.). In other words, the reduction of the viscosity, such as the viscosity reduction as a result of the breaking agent reacting with the polymeric material of the viscosified fluid to decompose and/or depolymerize the polymeric material, of the viscosified fluid does not substantially occur until the breaking agent is down hole and exposed to heat, such as a sufficient heat to initiate the breaking effect of the breaking agent. For example, at least 90% of the polymeric material remains unreacted or unbroken in that the molecular weight of the polymeric material remains unchanged), such as at least 95%, or as at least 99% of the polymeric material remains unreacted before the breaking agent is exposed to an intermediate temperature, such as downhole or subterranean conditions where the temperature is in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), that may act to initiate the breaking effect of the breaking agent.

In specific embodiments, the reduction of the viscosity, such as the viscosity reduction as a result of the breaking agent acting to decompose and/or depolymerize the polymeric material, of the viscosified fluid does not occur to any extent until the breaking agent is exposed to an intermediate temperature, such as downhole or subterranean conditions where the temperature is in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), that would initiate the breaking effect of the breaking agent.

In embodiments, the above breaking effect of the breaking agent may begin in at a time from about 5 minutes to about 600 minutes after being exposed to the intermediate temperature, such as a subterranean zone temperature or fracture temperature in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), such as a time from about 30 minutes to about 300 minute, time from about 45 minutes to about 150 minutes, or as time from about 60 minutes to about 90 minutes after being exposed to the intermediate temperature, such as a subterranean zone temperature or fracture temperature in the range of from about 79.4° C. (175° F.) to about 135° C. (275° F.), such as from about 79.4° C. (175° F.) to about 121° C. (250° F.), from about 93.3° C. (200° F.) to about 121° C. (125° F.), or from about 93.3° C. (200° F.) to about 107° C. (225° F.).

In embodiments, the breaking effect of the breaking agent may be accomplished either in the presence or absence of a breaker activator (also referred to as a “breaking aid”). A breaker activator may be present to encourage the redox cycle that activates the breaking agent. In some embodiments, the breaker activator may comprise an amine, such as an oligoamine activators, for example, tetraethylenepentaamine (TEPA) and pentaethylenehexaamine (PEHA); or a metal chelated with chelating agents. Suitable metals may include iron, chromium, copper, manganese, cobalt, nickel, vanadium, aluminum, and boron. Further breaker aids may include ureas, ammonium chloride and the like, and those disclosed in, for example, U.S. Pat. Nos. 4,969,526, and 4,250,044, the disclosures of which are incorporated herein by reference in their entireties.

The amount of breaker activator that may be included in the viscosified or unviscosified treatment fluid (or aqueous or organic based fluid) is an amount that will sufficiently activate the breaking effect of the breaking agent. Factors including the injection time desired, the polymeric material and its concentration, and the formation temperature. In embodiments, the breaker activator will be present in the viscosified or unviscosified treatment fluid (or aqueous or organic based fluid) in an amount in the range of from about 0.01% to about 1.0% by weight, such as from about 0.05% to about 0.5% by weight, of the viscosified or unviscosified treatment fluid (or aqueous or organic based fluid). In specific embodiments, no breaker activator may be present to sufficiently activate the breaking elect of the breaking agent.

The polymers present in the viscosified fluid may be those commonly used with fracturing fluids. The polymers may be used in either crosslinked or non-crosslinked form. The polymers may be capable of being crosslinked with any suitable crosslinking agent, such as metal ion crosslinking agents. Examples of such materials include the polyvalent metal ions of boron, aluminum, antimony, zirconium, titanium chromium, etc., that react with the polymers to form a composition with adequate and targeted viscosity properties for various operations. The crosslinking agent may be added in an amount that results in suitable viscosity and stability of the gel at the temperature of use. Crosslinkers may be added at concentrations of about 5 to about 500 parts per million (ppm) of active atomic weight. That concentration may be adjusted based on the polymer concentration.

The crosslinker may be added as a solution and may include a ligand which delays the crosslinking reaction. This delay may be beneficial in that the high viscosity fracturing fluid is not formed until near the bottom of the wellbore to minimize frictional pressure losses and may prevent irreversible shear degradation of the gel, such as when Zr or Ti crosslinking agents are used. Delayed crosslinking may be time, temperature or both time and temperature controlled to facilitate a successful fracturing process.

Other crosslinkers may include organic crosslinkers such as polyethyleneimines, aldehydes phenol-aldehydes, or urea-aldehydes. Suitable compounds include formaldehyde, formalin, paraformaldehyde, glyoxal, and glutaraldehyde. Compounds which react to form crosslinks include hexamethylenetetramine with phenolic compounds such as phenyl acetate, phenol, hydroquinone, resorcinol, and napthalene dials.

The polymers and amount used in the viscosified fluid may provide a fluid viscosity (from about 1 cP to about 100,000 cP at the treating temperature) that is sufficient to generate fracture width and facilitate transport and prevention of undue settling of the proppant within the fracture during fracture propagation. Generally, the polymer concentration is reduced to avoid proppant pack damage and maintain sufficient viscosity or opening the fracture and transporting proppant. In embodiments, the concentration of polymer may be selected to facilitate a primary goal of higher proppant loading in the fracture.

In embodiments, the viscosified fluids of the present disclosure may also be prepared from a fluid with crosslinkable components initially having a very low viscosity that can be readily pumped or otherwise handled and that are subsequently crosslinked, such as once it is downhole, to form the viscosified fluid. For example, the viscosity of the initial fluid with crosslinkable components may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature. In embodiments, the breaking agent comprising at least one organic peroxide having a structural feature selected from cyclic peroxide segment and/or multiple linear peroxide moieties per molecule may be present in the fluid with crosslinkable components initially having such a very low viscosity.

Crosslinking the unviscosified fluid with crosslinkable components generally increases its viscosity. As such, having the fluid in the unviscosified state allows for pumping of a relatively less viscous fluid having relatively low friction pressures within the well tubing, and the crosslinking may be delayed in a controllable manner such that the properties of viscosified fluid are available at the rock face instead of within the wellbore. Such a transition to a viscosified fluid state may be achieved over a period of minutes or hours based on the molecular make-up of the crosslinkable components, and results in the initial viscosity of the crosslinkable fluid increasing by at least an order of magnitude, such as at least two orders of magnitude. In embodiments, the breaking agent comprising at least one organic peroxide having a structural feature selected from cyclic peroxide segment and/or multiple linear peroxide moieties per molecule may be present in such crosslinked viscosified fluid. In embodiments, after the viscosity of the fluid has increased by at least an order of magnitude, such as at least two orders of magnitude, the action of the breaking agent comprising at least one organic peroxide having a structural feature selected from cyclic peroxide segment and/or multiple linear peroxide moieties per molecule may decrease the viscosity of the viscosified fluid by at least an order of magnitude (for example, reducing the viscosity from about 10000 centipoise at 100 sec⁻¹ at the treating temperature to about 1000 centipoise at 100 sec⁻¹ at the treating temperature) at the treating temperature, such as at least two orders of magnitude at the treating temperature, or to a viscosity below that of the initial unviscosified fluid (for example from about 10000 centipoise at 100 sec⁻¹ at the treating temperature to about 100 centipoise at 100 sec⁻¹ at the treating temperature).

In embodiments, the action (the breaking effect) of the breaking agent comprising at least one organic peroxide having a structural feature selected from cyclic peroxide segment and/or multiple linear peroxide moieties per molecule may reduce the viscosity of the viscosified fluid by at least one order of magnitude while the viscosified fluid is at a temperature in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), such as reducing the viscosity of the viscosified fluid by at least about one order of magnitude to about three orders of magnitude, or reducing the viscosity of the viscosified fluid by at least about one order of magnitude to about two orders of magnitude while the viscosified fluid is at a temperature in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.).

In embodiments, the action (the breaking effect) of the breaking agent comprising at least one organic peroxide having a structural feature selected from cyclic peroxide segment and/or multiple linear peroxide moieties per molecule may reduce the viscosity of the viscosified fluid by at least 80%, or by at least 95%, while the viscosified fluid is at a temperature in the range of from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 933° C. (200° F.) to about 107° C. (225° F.), such as reducing the viscosity of the viscosified fluid by at least 80% to about 99.99%, or reducing the viscosity of the viscosified fluid by at least about 95% to about 99% while the viscosified fluid is at a temperature in the range of from about 79.4° C. (175° F.) to about 135° C. (275° F.), such as from about 79.4° C. (175° F.) to about 121° C. (250° F.) from about 93.3° C. (200° F.) to about 121° C. (250° F.), or from about 93.3° C. (200° F.) to about 107° C. (225° F.).

The unviscosified fluids or compositions suitable in the methods of the present disclosure may comprise a crosslinkable component. As discussed above, a “crosslinkable component,” as the term is used herein, is a compound and/or substance that comprises a crosslinkable moiety capable of being crosslinked by a crosslinking agent. Suitable crosslinking agents for the methods of the present disclosure would be capable of crosslinking polymer molecules to form a three-dimensional network. Suitable organic crosslinking agents include, but are not limited to, aldehydes, dialdehydes, phenols, substituted phenols, and ethers. Suitable inorganic crosslinking agents include, but are not limited to, polyvalent metals, conventional chelated polyvalent metals, and compounds capable of yielding polyvalent metals. The concentration of the cross linking agent (including the spread crosslinker) in the crosslinkable fluid may be from about 0.001 wt % to about 10 wt %, such as about 0.005 wt % to a bout 2 wt %, or about 0.01 wt % to about 1 wt %.

The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gam, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, an alkylcarboxyalkyl cellulose, an alkyl cellulose, an alkylhydroxyalkyl cellulose, a carboxyalkyl cellulose ether, a hydroxymethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2 methyl-propane sulfonic acid, acrylic acid, acrylamide, or derivatives thereof. In embodiments, the crosslinkable components may present at about 0.01% to about 40% by weight based on the total weight of the crosslinkable fluid, such as at about 0.10% to about 2.0% by weight based on the total weight of the crosslinkable fluid.

Suitable solvents for use with the unviscosified fluid, viscosified fluid, and/or breaking agents comprising at least one organic peroxide (having a structural feature selected from cyclic peroxide segment and/or multiple linear peroxide moieties per molecule) employed in the methods of the present disclosure may be aqueous or organic based. In embodiments, the breaking agent may be introduced into the subterranean formation in a fluid (aqueous or organic) that is separate from the unviscosified fluid or viscosified fluid. In embodiments, the breaking agent may be introduced into the subterranean formation after being mixed into either an unviscosified fluid or a viscosified fluid. Aqueous solvents may include at least one of fresh water, sea water, brine, mixtures of water and water-soluble organic compounds and mixtures thereof. Organic solvents may include any organic solvent which is able to dissolve or suspend the various components of the crosslinkable fluid.

In embodiments, the solvent, such as an aqueous solvent, may represent up to about 99.9 weight percent of the unviscosified or viscosified fluid, such as in the range of from about 85 to about 99.9 weight percent of the viscosified fluid, or from about 98 to about 99.7 weight percent of the viscosified fluid.

While the viscosified fluids or viscosified treatment fluids of the present disclosure are described herein as comprising the above-mentioned components, it should be understood that the fluids of the present disclosure may optionally comprise other chemically different materials. In embodiments, the unviscosified and/or viscosified fluids of the present disclosure may further comprise stabilizing agents, surfactants, diverting agents, or other additives. Additionally, the unviscosified and/or viscosified fluids may comprise a mixture of various crosslinking agents, and/or other additives, such as fibers or filler, provided that the other components chosen for the mixture are compatible with the intended application, in embodiments, the unviscosified and/or viscosified fluids of the present disclosure may further comprise one or more components selected from the group consisting of a conventional gel breaker, a buffer, a proppant, a clay stabilizer, a gel stabilizer, a surfactant and a bactericide, Furthermore, the unviscosified and/or viscosified fluids may comprise buffers, pH control agents and various other additives added to promote the stability or the functionality of the fluid. The unviscosified and/or viscosified fluids may be based on an aqueous or non-aqueous solution. The components of the unviscosified and/or viscosified fluids may be selected such that they may or may not react with the subterranean formation that is to be sealed.

In this regard, the unviscosified and/or viscosified fluids may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the unviscosified and/or viscosified fluids may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified fluid after its formation downhole. Stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA) nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the spread crosslinker. Buffering agents may be added to the crosslinkable fluid or treatment fluid in an amount from about 0.05 wt % to about 10 wt % and from about 0.1 wt % to about 2 wt %, based upon the total weight of the unviscosified and/or viscosified fluids. Chelating agents may also be added to the unviscosified and/or viscosified fluids.

The aqueous base fluids of the fluids of the present application may generally comprise fresh water, salt water, sea water, a brine e.g., a saturated salt water or formation brine), or a combination thereof. Other water sources may be used, including those comprising monovalent, divalent or trivalent cations (e.g., magnesium, calcium, zinc, or iron) and, where used, may be of any weight.

Chelation is the formation or presence of two or more separate bindings between a multiple-bonded ligand and a single central atom. These ligands may be organic compounds, and are called chelating agents, chelants, or chelators. A chelating agent forms complex molecules with certain metal ions, inactivating the ions so that they, cannot normally react with other elements or ions to produce precipitates or scale. Example of chelating agents include nitrilotriacetic acid (NTA); citric acid; ascorbic acid; hydroxyethylethylenediaminetriacetic acid (HEDTA) and its salts including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts, phosphinopolyacrylate; thioglycolates; and a combination thereof. Other chelating agent are aminopolycarboxylic acids and phosphonic acids and sodium, potassium and ammonium salts thereof; HEIDA (hydroxyethyliminodiacetic acid); other aminopolycarboxylic acid members, including already EDTA and NTA (nitrilotriacetic acid), but also: DTPA (diethylenetriamine-pentaacetic acid), and CDTA (cycohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid.

Aqueous fluid embodiments may also comprise an organoamino compound. Examples of suitable organoamino compounds may include tetraethylenepentamine (TEPA), triethylenetetramine, pentaethylenehexamine, triethanolamine, and the like, or any mixtures thereof. When organoamino compounds are used in fluids described herein, they are incorporated at an amount from about 0.01 wt % to about 2.0 wt % based on total liquid phase weight. The organoamino compound may be incorporated in an amount from about 0.05 wt % to about 1.0 wt % based on total weight of the fluid.

Thermal stabilizers may also be included in the viscosified or unviscosified fluids. Examples of thermal stabilizers include, for example, methanol, alkali metal thiosulfate, such as sodium thiosulfate, and ammonium thiosulfate. The concentration of thermal stabilizer in the fluid may be from about 0.1 to about 5 weight %, from about 0.2 to about 2 weight %, from about 0.2 to about 1 weight % from about 0.5 to about 1 weight % of be thermal stabilizers based on the total weight of the fracturing fluid.

One or more clay stabilizers may also be included in the viscosified or unviscosified fluids. Suitable examples include hydrochloric acid and chloride salts, such as, tetramethylammonium chloride (TMAC) or potassium chloride. Aqueous solutions comprising clay stabilizers may comprise, for example, 0.05 to 0.5 weight % of the stabilizer, based on the combined weight of the aqueous liquid and the organic polymer i.e., the base gel). Surfactants can be added to promote dispersion or emulsification of components of the unviscosified and/or viscosified fluids, or to provide foaming of the crosslinked component upon its information downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944® (available from Baker Petrolite of Sugar Land, Tex.). A surfactant may be added to the crosslinkable fluid in an amount in the range of about 0.01 wt % to about 10 wt %, such as about 0.1 wt % to about 2 wt %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acryl amido-2-methyl-1-propane sulfonic acid) (poly AMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the unviscosified and/or viscosified fluids into lower-permeability areas when treating a zone with heterogeneous permeability. The use of diverting agents information treatment applications is known, such as given in Reservoir Stimulation, 3^{rd} edition, M. Econormides and K. Nohlte, eds., Section. 19.3.

The viscosified fluid for treating a subterranean formation of the present disclosure may be a fluid that has a viscosity of above about 50 centipoise at 100 sec⁻¹, such as a viscosity of above about 100 centipoise at 100 sec⁻¹ at the treating temperature, which may range from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (2001° F.) to about 107° C. (225° F.). In embodiments, the crosslinked structure formed that is acted upon by the breaking agent comprising one or more organic peroxide having a structural feature selected from cyclic peroxide segment and/or multiple linear peroxide moieties per molecule may be a gel that is substantially non-rigid after substantial crosslinking, in some embodiments, a crosslinked structure that is acted upon by the breaking agent comprising one or more organic peroxide having a structural feature selected from cyclic peroxide segment and/or multiple linear peroxide moieties per molecule is a non-rigid gel. Non-rigidity can be determined by any techniques known to those of ordinary skill in the art. The storage modulus G′ of substantially crosslinked fluid system of the present disclosure, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

The methods of the present disclosure may also employ a breaker in addition to the breaking activator (or breaking aid) described above. In this regard, conventional oxidizers, enzymes, or acids may be used. Such breakers reduce the polymers molecular weight by the action of an acid, an oxidizer, an enzyme, or some combination of these on the polymer itself in the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppart particles carried by the unviscosified and/or viscosified fluids remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used Naturally occurring materials may be underived and or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding chipping, or other form of particulation, processing, etc. Further information on nuts and composition thereof may be found in ENCYCLOPEDIA OF CHEMICAL TECHNOLOGY, Edited by Raymond E. Kirk and Donald F. Othmer, Third Edition, John Wiley & Sons, vol. 16, pp. 248-273, (1981).

The concentration of proppant in the unviscosified and/or viscosified can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the unviscosified and/or viscosified to achieve a variety of properties including improving particle suspension, and particle transport capabilities, and gas phase stability. Fibers used may be hydrophilic or hydrophobic in nature. Fibers can be any fibrous material, such as natural organic fibers, comminuted plant materials, synthetic polymer fibers (by non-limiting example polyester, polyaramide, polyamxide, novoloid or a novoloid-type polymer), fibrillated synthetic organic fibers, ceramic fibers, inorganic a fibers, metal fibers, metal filaments, carbon fibers, glass fibers, ceramic fibers, natural polymer fibers, and any mixtures thereof. Suitable fibers may include polyester fibers coated to be highly hydrophilic, such as, but not limited to polyethylene terephthalate (PET) fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in the unviscosified and/or viscosified fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use unviscosified and/or viscosified fluids containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

The foregoing may be better understood by reference to the following examples, which are presented for purposes of illustration and are not intended to limit the scope of the present disclosure.

### EXAMPLES

### Example 1

Breaking a polymer gel with 3,6,9-triethyl-3,6,9-trimethyl-1,4,7-triperoxonane.

2.4 grams of a guar sample was hydrated in 250 grams of tap water in a blender, in which the pH was adjusted with a 20% potassium hydroxide solution to be in the range of 7-8. After approximately 20 minutes, 0.15 grams of sodium thiosulfate thermal stabilizer was added. This was followed by adding 62.5 milliliters tetraethylenepentaamine (TEPA) breaker activator and then 0.4 milliliters of 3,6,9-triethyl-3,6,9-trimethyl-1,4,7-triperoxonane (95% in supporting oil). The pH was then adjusted to 12 using a 20% potassium hydroxide solution to 12.

Two oligoimine activators were tested, tetraethylenepentaamine (TEPA) and pentaethylenehexamine (PEHA). The inspection of the data reveals that these oligoimine activators showed analogous functionalities.

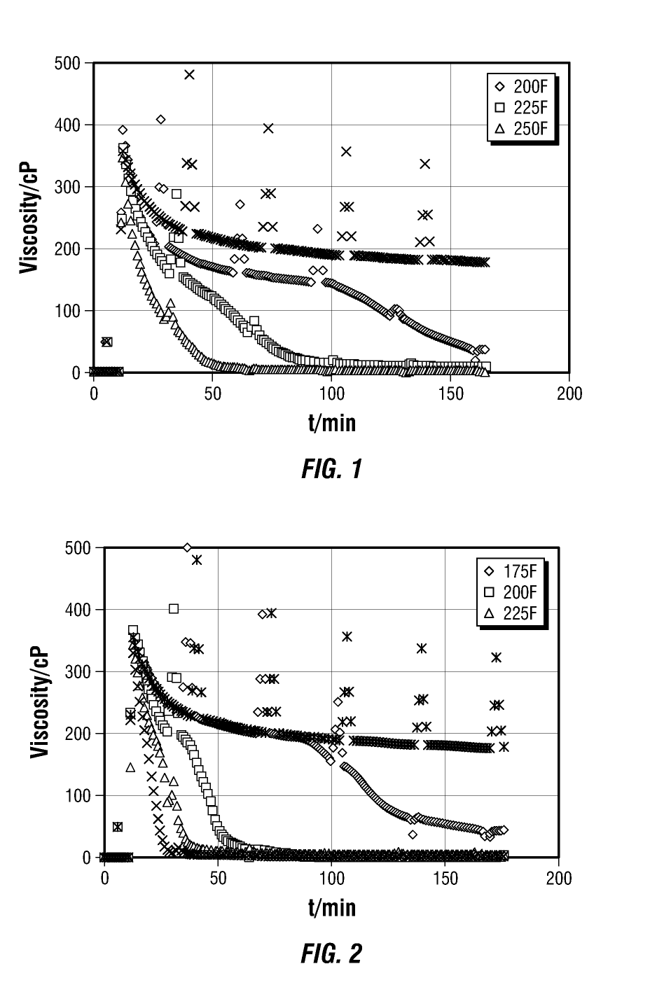

FIG. 1 illustrates the rheological profiles observed when 3,6,9-triethyl-3,6,9-trimethyl-1,4,7-triperoxonane was used to break 80 lb linear guar gel in the presence of TEPA. The rheological profiles were obtained on GRACE M5600 rheometers under a 100 s⁻¹ sheer rate with periodical sheer rates ramping. The polymer breaking took place at different time donmains that depend primarily on the exposed temperature. The elapsed time to break a given polymer gel is aversely proportional to the temperature to which the polymer gel is exposed. For instance, at a higher temperature of 250° F. (121.1° C.), the breaking began at about 34 minutes; at the middle temperature of 225° F. (107.2° C.), the onset of breaking was at about 55 minutes; while at the lower temperature of 200° F. (93.3° C.), the breaking began at 97 minutes.

### Example 2

Breaking a polymer gel with 1,1-di(tert-butylperoxy)-3,3,5-trimethylcyclohexane.

2.4 grams of a linear guar sample was hydrated in 250 grams of tap water in which the pH was adjusted with a 20% potassium hydroxide solution to be in the range of 7-8. After approximately 20 minutes, 0.15 grams of sodium thiosulfate thermal stabilizer was added. This was followed by adding 62.5 milliliters tetraethylenepentaamine (TEPA) breaker activator and then 0.4 milliliter of 1,1-di(tert-butylperoxy)-3,3,5-trimethylcyclohexane. The pH was then adjusted to 12 using a 20% potassium hydroxide solution before the fluid was transferred to a rheology cup for subsequent measurement.

FIG. 2 provides an illustration of the rheological profiles observed when 1,1-di(tert-butylperoxy)-3,3,5-trimethylcyclohexane was used to break 80 lb linear guar gel in the presence of TEPA. The rheological profiles were obtained on GRACE M5600 rheometers under a 100 s⁻¹ sheer rate with periodical shear rates ramping. The events of polymer breaking took place at different time domains that depend primarily on the exposed temperature. The elapsed time to break a given polymer gel is inversely proportional to the temperature to which the polymer gel is exposed. For instance, at a higher temperature of 250° F. (121.1° C.), the breaking started to occur at about 20 minutes; at 225° F. (107.2° C.) the onset of breaking was at about 30 minutes; while at 200° F. (93.3° C.), the breaking started at 40 minutes. At 175° F. (79.4° C.) the breaking took place at 90 minutes.

### Example 3

Breaking a crosslinked polymer gel with 1,1-di(tert-butylperoxy)-3,3,5-trimethylcyclohexane.

The fluid was prepared by first hydrating 0.9 grams guar in a blender containing 250 grams water for approximately 20 minutes. Next, the sodium thiosulfate (0.15 grams), TEPA (62.5 milliliter, approximately 92% by weight), potassium chloride (5 grams), d-sorbitol (0.06 milliliters), a borate based crosslinker composition (0.6 milliliters) and 1,1-di(tert-butylperoxy)-3,3,5-trimethylcyclohexane (0.3 milliliters, 41% by weight effective species) were added to the fluid. The pH was adjusted to 12 before the fluid was transferred to a rheology cup for subsequent measurement.

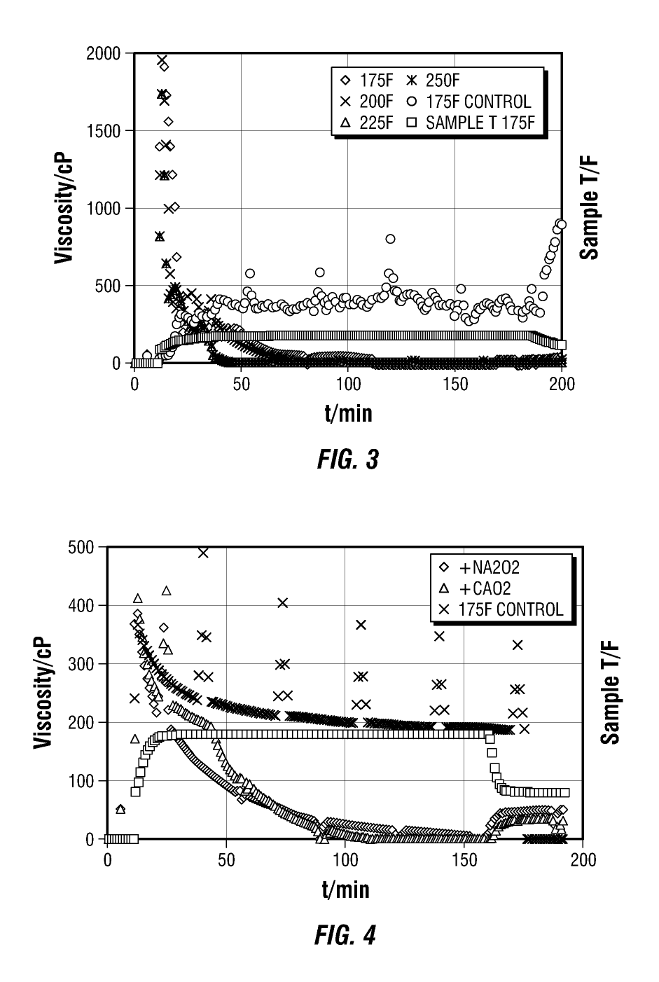

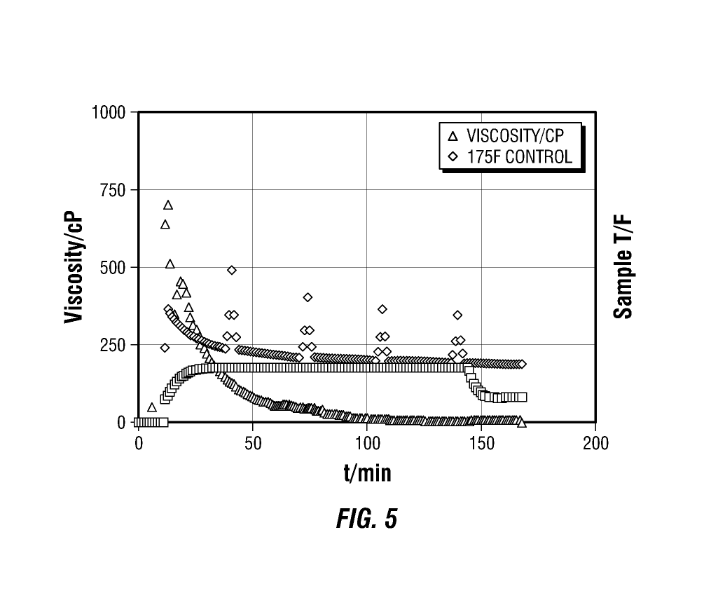

FIG. 3 illustrates the rheological profiles of 1,1-di(tert-butylperoxy)-3,3,5-trimethylcyclohexane breaking 30 lb guar gel crosslinked using a crosslinker composition in the presence of TEPA. The rheological profiles were also obtained on GRACE M5600 rheometers under a 100 s⁻¹ sheer rat with periodical sheer rates ramping. The events of polymer breaking took place at different time domains that depend primarily on the exposed temperature. The elapsed time to break a given polymer gel is inversely proportional to the temperature to which the polymer gel is exposed. For instance, at a higher temperature of 250° F. (121.1° C.), the breaking started to occur at about 20 minutes; at 225° F. (107.2° C.) the onset of breaking was at about 30 minutes while at 200° F. (93.3° C.) the breaking started at 35 minutes. At 175° F. (79.4° C.), the breaking took place at 45 minutes.

The data demonstrate that a single composition may be used over a wide temperature range and thus reflects the versatile performance of a breaking agent comprising at least one organic peroxide having a structural feature selected from cyclic peroxide segment and/or multiple linear peroxide moieties per molecule.

In comparison to other conventional organic peroxides disclosed in U.S. Pat. Nos. 7,678,745; 7,888,297; 7,159,658; 6,924,254; 7,915,336; and 7,456,212; the disclosures of which are incorporated herein by reference in their entireties, breaking agents comprising at least one organic peroxide having a structural feature selected from cyclic peroxide segment and/or multiple linear peroxide moieties per molecule are versatile in their breaking performance in particular toward the intermediate and lower end of the temperature domain, where the activation of the peroxide bond may be more challenging.

### Example 4

Breaking a polymer gel with 1,1-di(tert-butylperoxy)-3,3,5-trimethylcyclohexane in the presence of an inorganic peroxide.

Example 4 illustrates breaking a polymer gel in a binary mixture of organic and inorganic peroxides. Both peroxides may be pre-packed for storage, hence did not impact the well site blending protocol FIG. 4 shows the results obtained for 1,1-di(tert-butylperoxy)-3,3,5-dimethylcyclohexan blended with either sodium peroxide or calcium peroxide for effective breaking 80 lb guar linear gel at 175° F. (79.4° C.).

In Example 4, 2.4 grams of a guar linear gel sample was hydrated in 250 grams of tap water in which the pH was adjusted with a 20% potassium hydroxide solution to be in the range of 7-8. This was followed by adding 62.5 milliliters tetraethylenepentaamine (TEPA) breaker activator (92% solution) and then 0.4 milliliters of 1,1-di(tert-butylperoxy)-3,3,5-trimethylcyclohexane. 0.1 grams of sodium peroxide or 0.1 grams of calcium peroxide were then added to form two different solutions. The pH was then adjusted to 1.2 using a 20% potassium hydroxide solution and the fluid was transferred to a rheology cup for subsequent measurement. The rheological profiles were obtained at 175° F. (79.4° C.) on a GRACE M5600 rheometer under a 100 s⁻¹ sheer rate with periodical sheer rates ramping. The events of polymer breaking took place at different time domain depending on the type of metal peroxide. For instance, in the presence of sodium peroxide, the breaking took place from about 25 minutes, while calcium peroxide assisted the breaking to start from about 45 minutes.

### Example 5

Breaking a crosslinked polymer gel with 1,1-di(tert-butylperoxy)-3,3,5-trimethylcyclohexane in the absence of any breaker activator (also referred to as a “breaking aid”).

Example 5 demonstrates breaking polymer gel in the absence of any activator, and represents a favorable situation in terms of simplified storage and blending protocols at well site. 0.9 grams of a guar crosslinked gel sample was hydrated in 250 grams of tap water in which the pH was adjusted with a 20% potassium hydroxide solution to be in the range of 7-8. Next 0.30 grams of sodium thiosulfate, 5 grams of potassium chloride, 0.6 milliliters of the borate based crosslinker formulation, and 0.3 milliliters of 1,1-di(tert-butylperoxy)-3,3,5-trimethylcyclohexane (41% by weight effective species) and 0.3 milliliters of d-sorbitol were added to the polymer fluid. The pH was adjusted to 12 before the fluid was transferred to a rheology cup for subsequent measurement. The rheological profiles were obtained at 175° F. (79.4° C.) on a GRACE M5600 rheometer under a 100 s⁻¹ sheer rate with periodical sheer rates ramping. The break began at about 25 minutes.

### Example 6

Illustrates the combined effects of cost-effective activators of ammonium chloride and urea. The field water sample of exceptionally high total hardness was treated using cost-effective agent citric acid.

The field water sample was first treated by a mixture containing 250 grams of ammonium chloride, 0.5 grams (16.7 parts per thousand, “ppt”) of citric acid, and 0.25 grams (8.3 ppt) of potassium hydroxide to obtain a pH between 7-8. Next the guar polymer was fully hydrated for a period of 20 minutes and then added to the mixture. This was followed by the addition of a borate based crosslinker and 0.1 grams of, 1-di(tert-butylperoxy)-3,3,5-trimethylcyclohexane with the pH adjusted to 12 using sodium hydroxide.

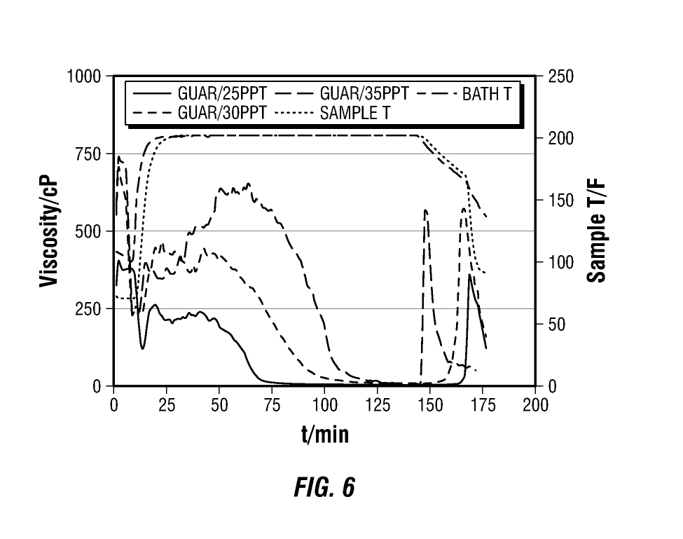

FIG. 6 shows the results obtained for a sample using a specific set of chemicals for water control and breaker activation purposes. The rheological profiles were obtained at 200° F. (93.3° C.) on a GRACE M5600 rheometer under a 100 s⁻¹ sheer rate with periodical sheer rates ramping. The break started at about 50, 65 and 80 minutes, respectively, depending on the polymer loading levels. In general the higher polymer loadings may involve longer break times to reach the desired reduced viscosity level.

### Example 7

Illustrates the combined effect of cost-effective activators of ammonium chloride and urea. The field water sample of exceptionally high total hardness was treated using cost-effective agent citric acid.

The 250 grams water sample was first treated using ammonium chloride (0.5 grams), citric acid (0.25 grams) with pH adjusted to between 7-8 using 20% sodium hydroxide. Next the polymer guar of predefined quantity (0.75, 0.90 and 1.05 grams respectively) was fully hydrated over 20 minutes, followed by adding urea (2 milliliters), borate-based crosslinker (0.6 milliliters) and 1-di(tert-butylperoxy)-3,3,5-trimethylcyclohexane (solid formulation, 0.1 grams) with the final pH adjusted to 12 using 1.4 milliliters 20% sodium hydroxide.

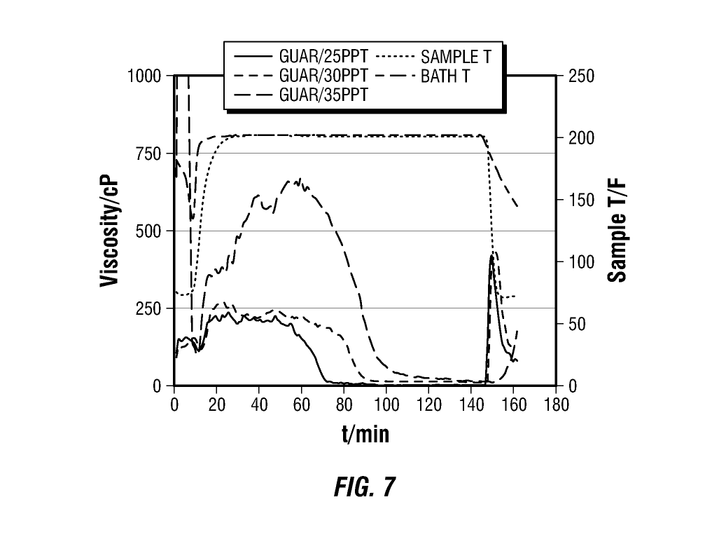

FIG. 7 shows the results obtained for a water sample using a set of chemicals for water control and breaker activation purposes. The rheological profiles were obtained at 200° F. (93.3° C.) on a GRACE M5600 rheometer under a 100 s⁻¹ sheer rate with periodical sheer rates ramping. The polymers were broken at 75, 90 and 105 minutes, respectively, depending on the polymer loading levels. In general, higher polymer loadings require longer time to break.

Although only a few example embodiments have been described in detail above, those skilled in the art will readily appreciate that many modifications are possible in the example embodiments without materially departing from METHOD AND COMPOSITION TO REDUCE GEL VISCOSITY IN THE INTERMEDIATE TEMPERATURE RANGE. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for reducing a viscosity of a viscosified fluid, comprising:
introducing a viscosified fluid to it subterranean formation; and
reducing the viscosity of the viscosified fluid by reacting the viscosified fluid with a breaking agent comprising at least one organic peroxide having a structural feature selected from a cyclic peroxide segment and/or multiple linear peroxide moieties per molecule; wherein
the viscosity of the viscosified fluid is reduced by at least an order of magnitude while in contact with the subterranean formation, and wherein the subterranean formation and the viscosified fluid have a temperature in the range of from about 75° F. to about 275° F.

2. The method of claim 1, wherein the at least one organic peroxide includes a cyclic peroxide having a ring structure of about 4 to about 16 atoms in which at least one peroxy structure represented by R₁—O—O—R₂ is incorporated into a ring structure of the cyclic peroxide, where R₁ and R₂, independently, are alkylene groups.

3. The method of claim 2, wherein the cyclic peroxide comprises about 3 to about 8 oxygen atoms in the cyclic peroxide ring structure.

4. The method of claim 1, wherein the at least one organic peroxide includes one or more compound represented by Formula I: 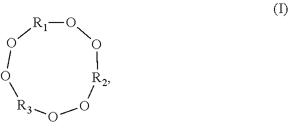
where R₁, R₂, and R₃, independently, are alkylene groups.

5. The method of claim 4, wherein the one or more compound represented by Formula I is a compound of Formula II:

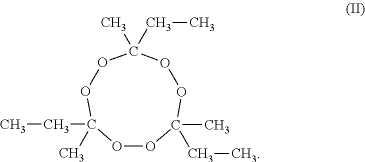 [SMILES: CCC1(C)OOC(C)(CC)OOC(C)(CC)OO1]

6. The method of claim 1, wherein the at least one organic peroxide includes one or more compound represented by Formula III: 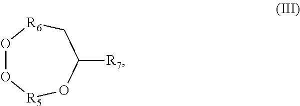
where R₅ and R₆, independently, are alkylene groups, and R₇ is a hydrogen or an unsubstituted or substituted alkyl group having about 1 to about 20 carbon atoms.

7. The method of claim 6, wherein the one or more compound represented by Formula III is a compound of Formula IV:

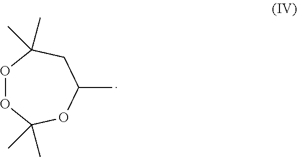

8. The method of claim 1, wherein the at least one organic peroxide comprises a molecule having at lea a two linear peroxide moieties, wherein the linear peroxide moieties are represented by the following structure: R₈—O—O—R₉, where R₈ and R₉, independently, are substituted or unsubstituted hydrocarbon groups.

9. The method of claim 8, wherein the at least two linear peroxide moieties are bonded to an alkylene group, arylene group, arylalkylene group, or alkylarylene group.

10. The method of claim 2, wherein the at least one organic peroxide further comprises a molecule having at least two linear peroxide moieties, wherein the linear peroxide moieties are represented by the following structure: R₈—O—O—R₉, where R₈ and R₉, independently, are substituted or unsubstituted hydrocarbon groups.

11. The method of claim 8, wherein molecule having at least two linear peroxide moieties is one or more member selected from the group consisting of 1,1-di(tert-butylperoxy)-3,3,5-trimethylcyclohexane, 2,5-dimethyl-2,5-di(tert butylperoxy)hexyne-3, and 2,5,-dimethyl-2,5-di(tert butylperoxy)hexane.

12. The method of claim 1, wherein the viscosified treatment fluid comprises a polymer selected from the group consisting of polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing, acrylamide, vinyl pyrrolidone, 2-acrylamido-2-methyl propane sulfonic acid and heteropolysaccharides.

13. The method of claim 1, wherein the viscosified fluid further comprises one or more components selected from the group consisting of a buffer, a proppant, a clay stabilizer, a gel stabilizer, a surfactant and it bactericide.

14. The method of claim 1, wherein the viscosity of the viscosified fluid is reduced by at least two orders of magnitude while in contact with the subterranean formation, wherein the subterranean formation and the viscosified fluid have a temperature in the range of from about 1.75° F. to about 275° F.

15. A method of treating a subterranean formation penetrated by a wellbore, the method comprising:
forming a viscosified treatment fluid;
treating the subterranean formation with the viscosified treatment fluid to fracture the subterranean formation; and
after the subterranean formation has been fractured, reducing the viscosity of the viscosified treatment fluid by at least 80% by introducing a breaking agent to the viscosified treatment fluid, the breaking agent comprising at least one organic peroxide having a structural feature selected from a cyclic peroxide segment and/or multiple linear peroxide moieties per molecule; wherein the viscosity of the viscosified treatment fluid is reduced by at least 80% at a temperature in the range of front about 175° F. to about 275° F.

16. The method of claim 15, wherein the viscosified treatment fluid comprises a polymer selected from the group consisting of polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides.

17. The method of claim 16, wherein the breaking agent is present in the viscosified treatment fluid in an amount from greater than 0% to about 0.5% by weight of the polymer in the viscosified treatment fluid.

18. The method of claim 15, wherein the viscosity of the viscosified treatment fluid is reduced by at least 95% by contacting the viscosified treatment fluid with the breaking agent.

19. The method of claim 15, wherein the at least one organic peroxide includes a cyclic peroxide having a ring structure of about 4 to about 16 atoms in which at least one peroxy structure R₁—O—O—R₂ is incorporated into a ring structure of the cyclic peroxide, where R₁ and R₂, independently, are alkylene groups.

20. The method of claim 15, wherein the at least one organic peroxide includes one or more compound represented by Formula I: 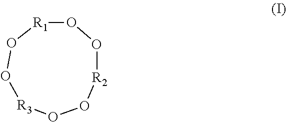
where R₁, R₂, and R₃, independently, are alkylene groups.

21. The method of claim 20, wherein the one or more compound represented by Formula I is a compound of Formula II.

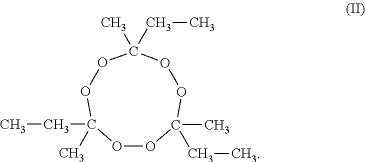 [SMILES: CCC1(C)OOC(C)(CC)OOC(C)(CC)OO1]

22. The method of claim 15, wherein at least one organic peroxide is one or more member selected from the group consist of 1,1-di(tert-butylperoxy)-3,3,5-trimethylcyclohexane, 2,5-dimethyl-2,5-di(tert butylperoxy)hexyne-3, and 2,5-dimethyl-2,5-di(tert butylperoxy)hexane.
